(19) United States
(12) Patent Application Publication
(10) Pub. No.: US 2007/0194088 A1
(43) Pub. Date: Aug. 23, 2007

(54) Assembly means for parts comprising at least one weld bead produced by transparency

(76) Inventors: Ludovic Goby, Paris (FR); Philippe Aubert, Paris (FR)

Correspondence Address: ANDERSON, KILL & OLICK, P.C., 1251 AVENUE OF THE AMERICAS, NEW YORK,, NY, 10020-1182, US

(21) Appl. No.: 10/562,996

(22) PCT Filed: Jun. 30, 2004
(86) PCT No.: PCT/FR04/50297

§ 371 Date: Dec. 27, 2005

(30) Foreign Application Priority Data
Jul. 2, 2003 (FR) 03/50283

(51) Int. Cl. B23K 26/28; B21D 39/00

(52) U.S. Cl. 228/153

(57) ABSTRACT

The invention relates to assembly means (101) for parts, comprising at least one weld bead (106,206) produced by transparency and intended to fix at least two parts (2, 4) to each other, each weld bead (106) having a start point (114) and an end point (126). According to the invention, at least one weld bead (106) defines at least one closed line (116,124) delimiting an internal zone (117, 125) within which at least one of said start and end points (114,126) of this weld bead (106) is located. Particularly applicable to the domain of assembling components of automobile vehicle bodies.

### TECHNICAL DOMAIN

This invention relates to assembly means for parts in general comprising at least one weld bead produced by transparency and intended to fix at least two parts to each other.

Furthermore, the invention is also related to a method of assembling parts in general, comprising production of such assembly means.

The invention is particularly applicable to the domain of assembling components of automobile vehicle bodies.

### STATE OF PRIOR ART

Conventionally, it is known that making a weld bead by transparency creates weld bead start and end points at which cracks occur, created by the thermal shock that occurs at the start and end of the welding procedure, regardless of the technique used.

It is also known that weld bead start and end points, with cracks, are highly stressed locations when external mechanical stresses are applied to the welded assembly.

Consequently, these start and end points at which incipient failure occurs in fatigue, are the parts on the weld bead that fail in priority and trigger failure of the entire weld bead assembly.

Several solutions are known in prior art to overcome this disadvantage.

A first solution shown in FIG. 1 consists globally of closing the weld bead on itself at a weld start zone and at a weld end zone.

As shown in this FIG. 1, the two plate-type parts 2 and 4 are assembled using a weld bead 6 made by transparency, namely this weld bead 6 makes a rigid mechanical connection between two superposed parts belonging to the two parts 2 and 4 respectively. This bead 6 comprises a straight central zone called the useful zone 8, the length of which is considered to be sufficient to form a rigid connection between the two superposed parts 2 and 4. Furthermore, this useful straight zone 8 is prolonged by a weld bead start zone 10 and a weld bead end zone 12.

As mentioned above, the weld bead 6 effectively closes on itself at the weld bead start zone 10 and the weld bead end zone 12. In other words, it can be seen that the weld bead start zone 10 prolongs the useful zone 8 along a straight line, before curving and returning to this zone 8 such that the weld bead start point 14 at the beginning of the zone 10 is located in the straight part of this zone, close to the useful zone 8. Thus, the weld bead start zone 10 is composed mainly of a closed line 16, in the sense that the cracked start point of the weld bead 14 is located in the straight part of the weld bead.

In this way, the effects provoked by the external mechanical stresses (shown diagrammatically by the arrows in FIG. 1), on the cracks 18 at the end 14, are significantly lesser than those encountered in the conventional solution in which the weld bead is not closed at its ends. Stresses are distributed over the entire weld start zone 10, and therefore all around the closed line 16, and no longer directly and exclusively on the cracked weld bead start point 14.

Furthermore, it should be noted that in this so-called <<moustache>> solution, the weld bead end zone 12 is made in practically the same manner as the weld bead start zone 10 described above.

Nevertheless, it should be noted that although this solution improves the fatigue strength of the welded assembly, it does not correspondingly eliminate risks of failure of the weld bead initiated from the weld bead start and end points, under the effect of external mechanical stresses.

Another solution suggested in prior art is to start and stop the weld bead in mechanically unstressed zones in the assembly. However, this solution is not very widespread in the sense that these specific zones may be far from the zone in which the weld bead is really needed, and in some cases there are no such zones, and in any case they are very difficult to detect. Furthermore when this technique is adopted, apart from the need to make a longer weld bead than intended, there may be some difficulties in accessing these specific zones particularly when the welded assembly forms an integral part of a vehicle body.

A third possibility envisaged in prior art was to break the weld bead down into a plurality of weld portions with shorter lengths, arranged to be at a spacing from each other. In this configuration, only the two portions of the weld bead located at the ends are stressed. Thus, when this/these weld end portions fail, the adjacent weld portions are mechanically stressed in turn, and so on.

In this respect, it should be noted that although this solution effectively improves the fatigue resistance to external mechanical stresses compared with a single weld bead, it is only applicable to long connections and inevitably leads to a reduction in the static strength.

A final proposal according to prior art consists of inserting rivet type attachment means at the connection ends between consecutive weld bead portions. In this way, the portions of the weld bead in the rigid connection obtained provide the static strength of the assembly of parts welded to each other, while the rivets are designed to protect the start and end point of each weld bead portion where cracks are initiated, thus eliminating external mechanical stresses in fatigue.

Although this solution is satisfactory in terms of the mechanical strength of the welded assembly, it does require the use of various assembly techniques, that directly increases manufacturing times and costs.

It should be noted that all the solutions proposed above disclose unclosed connections, in other words connections formed by a weld bead with two ends at a distance from each other and not connected together, as was illustrated for the first solution proposed in prior art. However, the problems listed above and related to these solutions occur in cases in which closed connections are required, in other words the weld bead should have two fairly close or even coincident ends, and in any case they should be connected together. In this respect, this closed connection case occurs particularly when the weld bead made by transparency is in the form of a circular bead, and therefore a closed line. In this configuration, the cracked start and end of the weld bead are located within the closed line forming the useful part of the weld bead, consequently the risks of failure of this weld bead with initiated cracks starting from these cracked ends are also relatively high, under the effect of external mechanical stresses.

### OBJECT OF THE INVENTION

Therefore, the purpose of the invention is to provide means of assembling parts comprising at least one weld bead made by transparency and designed to fix at least two parts to each other, these means at least partially overcoming the disadvantages mentioned above related to embodiments of prior art.

Furthermore, another purpose of the invention is to present a method for assembling parts including the production of such assembly means.

To achieve this, the first object of the invention is means for the assembly of parts comprising at least one weld bead made by transparency and designed to fix at least two parts to each other, each weld bead having a start and end point. According to the invention, at least one weld bead defines at least one closed line delimiting an internal zone within which at least one of the weld bead start and end points is located.

Advantageously, if either the start or end point of a weld bead is located within an internal zone delimited by a closed line formed by this weld bead, which by definition is continuous, it is possible to completely isolate the cracked end(s) concerned from a useful zone of the weld bead. Obviously, this technical effect occurs both during the construction of an unclosed connection such as a straight weld bead and during the formation of a closed connection such as a circular weld bead.

Thus, an assembly of parts provided with such assembly means according to the invention has a considerably better resistance to fatigue than the assembly obtained with the use of the first solution described according to prior art, without it being necessary to search for mechanically unstressed zones to start or end a weld bead, or to use several different assembly techniques. Furthermore, the fact that the invention consists of forming at least one weld bead, therefore producing a continuous connection, means that the global mechanical strength of the assembly is significantly better than the mechanical strength achieved by the use of portions of weld beads at a spacing from each other.

Furthermore, it is naturally noted that the weld bead(s) of the assembly means according to the invention are easy to make with any welding technique, for example TIG, MIG or laser.

If it is required to obtain one or more unclosed mechanical connections, it would be possible for the assembly means to include at least one weld bead including a weld bead start zone beginning at the weld bead start point and a weld bead end zone terminating at the weld bead end point, and at least the weld start zone or the weld end zone defines a closed line delimiting an internal zone inside which its associated weld bead start/end point is located. Thus with this arrangement, the high external mechanical stresses applied to the weld bead start and end zones will not have any effect on the cracked ends located inside the closed lines formed by these zones, since these stresses are absorbed by these closed lines before they can propagate towards the end cracks.

Preferably, weld bead start and end zones for at least one weld bead are formed outside a useful zone of this weld bead, and each closed line is approximately in the form of a circle.

In the other case in which it is required to obtain one or more closed mechanical links, at least one weld bead can be provided to define a single closed line forming a useful zone of this weld bead, and the start or end or preferably both weld beads are located in the internal zone delimited by this single closed line.

Thus once again, the external mechanical stresses applied all around the single closed line have no effect on the cracked ends located inside the internal zone delimited by this closed line, to the extent that these stresses are absorbed by this same closed line forming the useful zone of the weld bead, before they can propagate towards the cracks in the weld bead start and end zones.

Obviously, the assembly means according to the invention may jointly include at least one unclosed connection and at least one closed connection like those described above, without going outside the scope of the invention.

Another object of the invention is a method for the assembly of parts comprising a step to produce at least one weld bead by transparency, designed to fix at least two parts to each other, each weld bead having a weld bead start point and a weld bead end point. According to the invention, this step to produce at least one weld bead by transparency is implemented such that at least one weld bead defines at least one closed line delimiting an internal zone inside which at least the start or the end of this weld bead is located.

Other advantages and characteristics of the invention will become clear after reading the detailed and non-limitative description given below.

### BRIEF DESCRIPTION OF THE DRAWINGS

This description will be made with reference to the drawings among which:

FIG. 1, already described, shows a diagrammatic top view of an assembly of two parts fixed to each other by conventional assembly means according to prior art;

FIG. 2 shows a diagrammatic top view of an assembly of two parts fixed to each other by assembly means according to a first preferred embodiment of the invention; and

FIG. 3 shows a diagrammatic top view of an assembly of two parts fixed together by assembly means according to a second preferred embodiment of the invention.

### DETAILED DESCRIPTION OF PREFERRED EMBODIMENTS

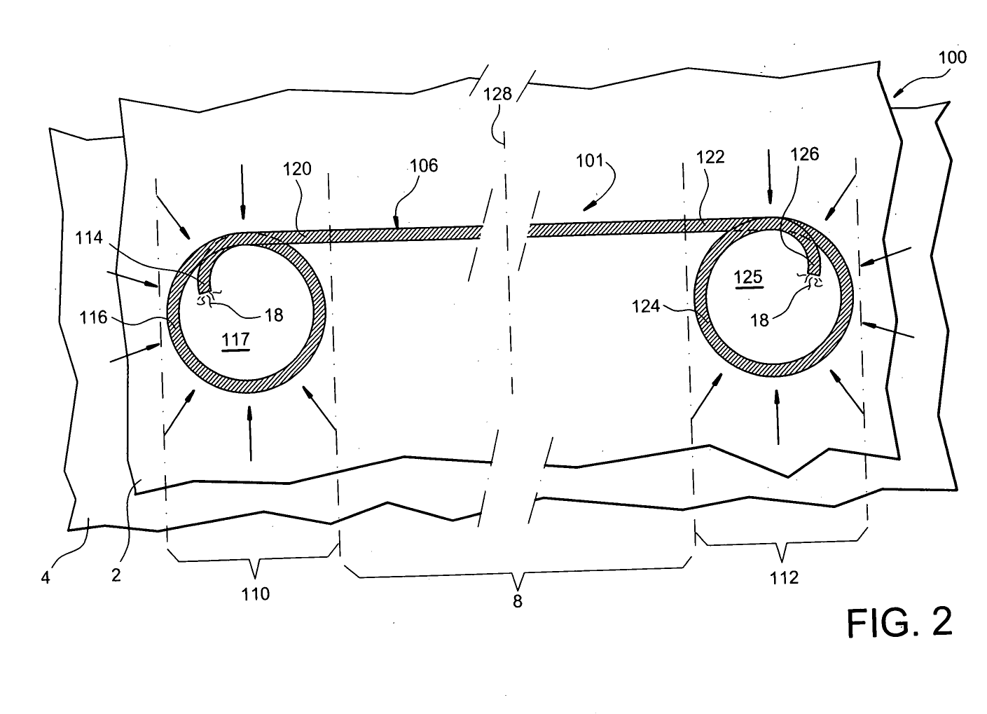

An assembly 100 of two parts 2 and 4 fixed together by assembly means 101 according to a first preferred embodiment of the invention is shown with reference to FIG. 2.

Obviously, the assembly means 101 can be designed to fix more than two parts to each other, without going outside the scope of the invention.

Furthermore, it is also indicated that in this first preferred embodiment of this invention, the assembly means 101 comprise a single weld bead 106 that will be disclosed in detail below, but naturally can include more than one weld bead.

As shown in FIG. 2, the weld bead 106 is of the unclosed connection type made by transparency, in order to fix the two plate type parts 2 and 4 to each other arranged so as to at least partially overlap each other.

The weld bead 106 comprises a useful zone 8 preferably in the form of a straight line and sized so that it alone forms a rigid connection between parts 2 and 4, regardless of the type of external mechanical stresses applied. Nevertheless, it is specified that this useful zone 8 can also be of the unclosed curved line type without going outside the scope of the invention.

There is a weld bead start zone 110 on one side of the useful zone 8, and a weld bead end zone 112 on the other side.

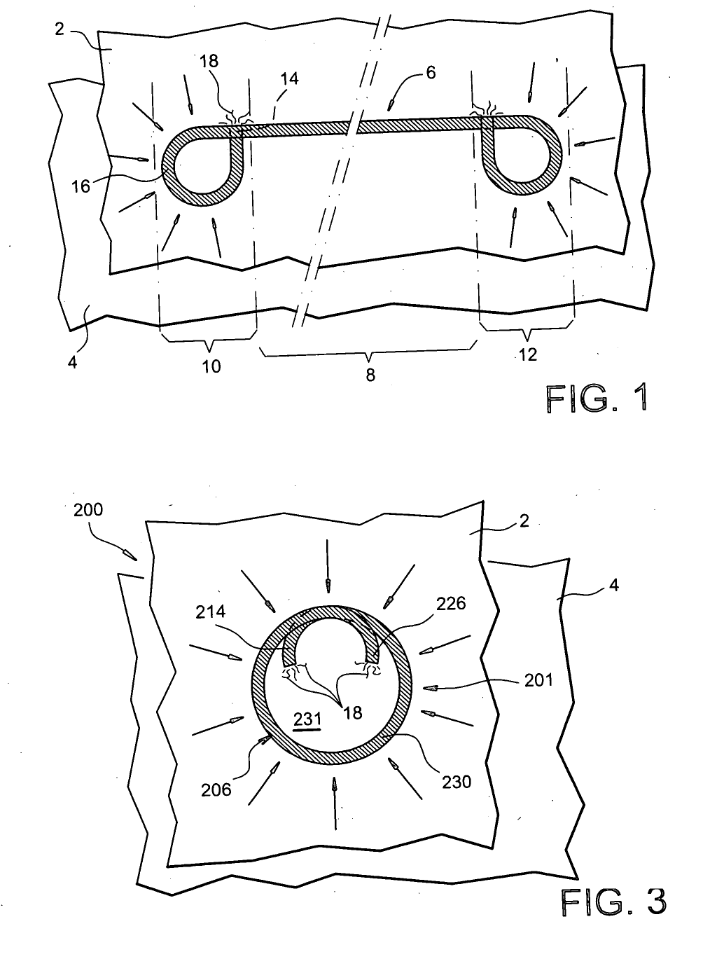

Also with reference to FIG. 2, it can be seen that the weld bead start zone 110 is similar in some respects to the weld bead start zone 10 shown in FIG. 1 and diagrammatically representing prior art. The weld bead start zone 110 is such that the weld bead 106 is closed on itself in this zone. In other words, it can be seen that the weld start zone 110 prolongs the useful zone 8, and then curves so as to define a closed line 116 preferably in the form of a closed circle. This closed line 116 delimits an internal zone 117 that is consequently globally in the form of a disk, composed of a part of each of the two parts 2 and 4.

The special feature of this weld bead start zone 110 lies in the fact that a weld bead start point 114 at the beginning of this zone 110 is not located on the closed line 116, but is inside the internal zone 117 delimited by this line. Therefore as can be clearly seen in FIG. 2, it should be understood that the weld forming the weld bead start zone 110 does not terminate at a junction such that the closed line 116 can be obtained as in prior art shown in FIG. 1, but is prolonged by moving towards the inside of this closed line 116, such that at least the end 114 is in the internal zone 117.

In this respect, it should be noted that the length of the weld bead start point 114 can be of the order of 6 mm, and the total length of the weld bead located inside this closed line 116 can be about 10 mm. Obviously, these dimensions are given for illustrative purposes, and it should naturally be understood that the weld bead 106 is made such that the cracks 18 at the first end 114 are located within the internal zone 117 delimited by the closed line 116, and preferably at a reasonable distance from this line, preferably more than 5 mm. Furthermore, it would be possible to attempt to position the centers of the closed lines 116 and 124 so as to produce the ends 114 and 126 respectively.

In this way, the cracks 18 located at the weld bead start point 114 are at a distance from the closed line 116 and are therefore completely isolated from the useful zone 8 by remaining inside this line, which very much improves the fatigue strength of the assembly 100. This improvement is explained particularly by the fact that the external mechanical stresses (shown diagrammatically by the arrows in FIG. 2) are distributed over the entire weld bead start zone 110 and therefore all around the closed line 116 on which they are stopped without being able to reach the cracks 18 at the weld bead start point 114.

It should be noted that while the weld bead 106 is being produced, this weld bead is naturally made to be continuous by defining the weld start point 114, the closed line 116, a junction portion 120 of the zone 110 located between the closed line 116 and the useful zone 8, then this useful zone 8 and the weld bead end zone 112 as described in detail below.

In general, the design of the weld bead end zone 112 is practically the same as the design of the weld bead start zone 110. During production of the zone 112 of the weld bead 106, the first step is to form a junction portion 122 located between the useful zone 8 and a closed line 124 defined by this zone 112, this closed line 124 delimiting an internal zone 125, and the next step is to produce a bead end zone 126 completing the zone 112 and arranged such that it is located inside the internal zone 125 delimited by the closed line 124.

Furthermore, it can be seen that in this first preferred embodiment of this invention, the weld bead 106 considered in the diagrammatic view in FIG. 2, has a symmetric geometry about a centerline 128 intersecting the useful zone 8 perpendicularly through the middle.

Consequently, the cracks 18 at the weld bead end point 126 are at a distance from the closed line 124 and are therefore completely isolated from the useful zone 8 by remaining inside this line, which very much improves the fatigue strength of the assembly 100.

With reference to FIG. 3, the figure shows an assembly 200 of two parts 2 and 4 fixed to each other by assembly means 201 according to a second preferred embodiment of this invention.

Once again, the assembly means 201 could be designed to fix more than two parts to each other, without going outside the scope of the invention.

Furthermore, in this second embodiment of this invention, the assembly means 201 comprise a single weld bead 206 that will be disclosed in detail below, but that could naturally include more than one weld bead.

As can be seen in FIG. 3, the weld bead 206 is of the closed connection type, and is made by transparency in the same way as for the first preferred embodiment of this invention.

The weld bead 206 is composed mainly of a useful zone in the form of a single closed line 230, preferably circular and sized so that it alone forms a rigid connection between parts 2 and 4, regardless of the type of external mechanical stresses applied. This closed line 230 delimits an internal zone 231 that is consequently preferably in the global form of a disk, consisting of a part of each of the two parts 2 and 4.

The special feature of this weld bead 206 lies in the fact that it includes a weld bead start point 215 and a weld bead end point 226 that are not located on the single closed line 230 as was the case according to prior art, but both are arranged so as to be inside the internal zone 231 delimited by this closed line 230.

Therefore as can be seen clearly in FIG. 3, it should be understood that the weld forming the useful zone, and therefore the closed line 230, does not terminate at a junction used to obtain this line 230, but is prolonged by moving towards the interior of this closed line 230 such that at least the ends 214 and 226 are located in the internal zone 231 closed by the parts 2 and 4.

Once again as an illustrative example, the ends 214 and 226 may be of the order of 6 mm long, and the total length of the weld bead located inside this closed line 230 at each end 214 and 226 may be about 10 mm. Once again, the ends 214 and 226 may be located close to the center of the closed line 230.

The weld bead 206 will be made to be continuous, by defining firstly the weld bead start 214, then the closed line 230, then the weld bead end 226.

In this way, the cracks 18 located at the start point 214 and end point 226 of the weld bead are at a distance from the closed line 230 and are therefore completely isolated inside this line forming the useful zone of the weld bead 206, which very much improves the fatigue strength of the assembly 100. This improvement is explained particularly by the fact that external mechanical stresses (shown diagrammatically by the arrows in FIG. 3) are distributed all around the closed line 230 at which they are stopped without being able to reach the cracks 18 at the weld bead start and end points 214 and 226.

Obviously, a person skilled in the art could make various modifications to the assembly means 101 and 201 that have just been described above, solely as non-limitative examples.

1. Assembly means (101,201) for parts, comprising at least one weld bead (106,206) produced by transparency and intended to fix at least two parts (2, 4) to each other, each weld bead (106,206) having a start point (114,214) and an end point (126,226), characterised in that at least one weld bead (106,206) defines at least one closed line (116,124,230) delimiting an internal zone (117, 125, 231) within which at least one of said start and end points (114,214,126,226) of this weld bead (106,206) is located.

2. Assembly means (101) for parts according to claim 1, characterised in that at least one weld bead (106) includes a weld bead start zone (110) beginning at its weld bead start point (114), and a weld bead end zone (112) terminating at its weld bead end point (126), and in that at least one of the weld start and weld end zones (110,112) defines a closed line (116,124) delimiting an internal zone (117, 125) inside which its associated weld bead start/end point is located (114,126).

3. Assembly means (101) according to claim 2, characterised in that for at least one weld bead (106), the weld bead start and end zones (110,112) are arranged outside a useful zone (8) of this weld bead (106).

4. Assembly means (101) for parts according to claim 1, characterised in that for at least one weld bead (106), each closed line (116,124) is in the form of a circle.

5. Assembly means (201) for parts according to claim 1, characterised in that at least one weld bead (206) defines a single closed line (230) forming a useful zone for this weld bead (206), and in that at least one of the start and end points (214,226) of this weld bead (206) is located in the internal zone (231) delimited by this single closed line (230).

6. Assembly method for parts, comprising a step to produce at least one weld bead (106,206) by transparency, designed to fix at least two parts (2, 4) to each other, each weld bead (106,206) having a weld bead start point (114,214) and a weld bead end point (126,226), characterised in that this step to produce at least one weld bead by transparency is implemented such that at least one weld bead (106,206) defines at least one closed line (116,124,230) delimiting an internal zone (117, 125,231) inside which at least said start or the end (114,214,126,226) of this weld bead (106,206) is located.
